(19) United States
(12) Patent Application Publication
(10) Pub. No.: US 2026/0366811 A1
(43) Pub. Date: Nov. 19, 2026

(54) DEVICE AND METHOD FOR DRYING AND PUFFING

(71) Applicant: SAJA GmbH, Vaduz (LI)

(72) Inventors: Georg Weisz, Freising (DE); Elmar Wefers, Aschheim (DE); Michael Wefers, München (DE); Thomas Dibke, Oberägeri (CH)

(21) Appl. No.: 19/132,426

(22) PCT Filed: Nov. 21, 2023
(86) PCT No.: PCT/EP2023/082523

§ 371 Date: May 23, 2025

(30) Foreign Application Priority Data
Nov. 23, 2022 (DE) 10 2022 131 025.6

(51) Int. Cl. F26B 3/347; H05B 6/64

(52) U.S. Cl. CPC F26B 3/347; H05B 6/64

(57) ABSTRACT

A device for drying and puffing organic, moist products, including a microwave treatment chamber, at least one post-drying container having a first infrared radiation source, at least one cooling container having a second infrared radiation source, and a discharge airlock, which are each connected to at least one vacuum unit, wherein the post-drying container and the cooling container each have a plurality of receiving compartments for product trays, which receiving compartments are arranged substantially one above the other in the vertical direction, and wherein a displacement unit is provided upstream of each of the post-drying container and the cooling container in the conveying direction of the product trays, and the height position of the receiving compartments and of the displacement units relative to one another can be changed in order to load the receiving compartments individually with product trays for continuous operation and/or to unload the receiving compartments.

### CROSS REFERENCE TO RELATED PATENT APPLICATIONS

This is a U.S. national phase patent application of PCT/EP2023/082523 filed Nov. 21, 2023, which claims the benefit of and priority to German Patent Application No. 10 2022 131 025.6, filed on Nov. 23, 2022, the entire contents of each of which are incorporated herein by reference for all purposes.

### TECHNICAL FIELD

The invention relates to a device for drying and puffing organic, water-moist products, in particular fruits and/or vegetables. Furthermore, the invention relates to a method for drying and puffing such products.

### BACKGROUND

EP 2 408 322 B1 describes a device that makes it possible to achieve particularly efficient and cost-effective drying of organic, water-moist products by supplying microwave energy, while maintaining a high product quality. The device comprises a microwave treatment chamber and at least one post-drying container comprising an infrared radiation source. The product pre-dried in the microwave treatment chamber is further dried in the post-drying container by the infrared radiation source. In order to reduce the temperature generated in the product by the drying process, an infrared sink is also provided in the post-drying container, which is positioned downstream of the infrared radiation source in the direction of movement of the product to be dried. The dried and cooled products leave the device via a discharge airlock.

In the known device, the microwave treatment chambers and the post-drying container as well as the discharge airlock are each connected to at least one vacuum unit in order to generate a vacuum in the corresponding chambers.

### SUMMARY

The use of a microwave treatment chamber has led to significant improvements in product quality while at the same time increasing efficiency in terms of energy input and energy consumption. Nevertheless, it has been shown that further improvements are useful and possible.

In this respect, the invention sets itself the object of providing a device for drying and puffing organic, water-moist products, which has an even higher efficiency and can be used to increase productivity. Furthermore, it is the object of the invention to provide a method for drying and puffing organic, water-moist products with such a device.

This object is solved with regard to the device for drying and puffing organic, water-moist products as shown and described herein.

Thus, the invention is based on the idea of providing a device for drying and puffing organic, water-moist products, in particular fruits and/or vegetables, wherein the device has a microwave treatment chamber, at least one post-drying container having a first infrared radiation source, at least one cooling container having a second infrared radiation source and a discharge airlock, which are each connected to at least one vacuum unit. According to the invention, the post-drying container and the cooling container each have a plurality of receiving compartments for product trays, which receiving compartments are arranged substantially vertically. In each case, a displacement unit is arranged upstream of the post-drying container and the cooling container in the conveying direction of the product trays. The height position of the receiving compartments and the displacement units can be changed relative to each other in order to load the receiving compartments individually with product trays for continuous operation and/or to unload them.

The particular advantage of the invention is that the multiple receiving compartments for product trays, the height of which can be adjusted relative to one another, enable continuous drying of a large number of products. The device can therefore be used in continuous operation. The post-drying container is in continuous operation and dries products on several product trays at the same time. This increases the process speed and thus the efficiency of the device. The transfer unit, which can transfer individual product trays from one process step to the next, also contributes to this. In this way, the transfer unit can transfer the product trays from the microwave treatment chamber to the post-drying container and, in particular, from the post-drying container to the cooling container when the desired degree of drying for this product tray has been reached. The displacement unit and the receiving compartments, which are arranged vertically and can be adjusted in height, work together in such a way that continuous loading and unloading of the post-drying container is essentially made possible.

Overall, the invention reduces idle times for the post-drying container and the cooling container. The drying process in the microwave treatment chamber requires considerably less time than the post-drying process in the post-drying container under the influence of the infrared radiation sources. Previously, the microwave treatment chamber could therefore only be reloaded with a new product tray once the post-drying process in the post-drying container had been completed. With the invention, on the other hand, product trays can be introduced into the microwave treatment chamber at a continuous rate, which can also be passed on to the post-drying container at the same rate. In particular, this can be carried out automatically.

As the product trays can be inserted into individual receiving compartments, the dwell time of the individual product trays can be maintained on the one hand in order to achieve sufficient post-drying. On the other hand, product trays can be introduced into the receiving compartments at continuous intervals so that there are no idle times for the microwave treatment chamber. In addition, product trays can also be transferred from the post-drying container to the cooling container after the post-drying time has elapsed. The transfer units are used for this purpose. The same applies to loading and unloading the discharge airlock. In particular, the displacement units allow the device to be emptied under its own power so that no empty product trays remain in the device.

Preferably, a control unit is provided which is connected at least to the microwave treatment chamber, the post-drying container, the cooling container and the displacement units.

The control unit can be configured for continuous operation in such a way that
a) the receiving compartments of the post-drying container can be successively loaded with product trays from the microwave treatment chamber, and
b) the product trays can be continuously conveyed into the receiving compartments of a subsequent container, in particular a further post-drying container or the cooling container, by the displacement unit arranged upstream of the post-drying container once the respective target post-drying degree has been reached.

The control unit ensures continuous operation in terms of process technology. The multiple receiving compartments allow several products to be dried simultaneously on different product trays, wherein the degree of drying depends on the time of loading. The product trays are then conveyed continuously depending on the degree of drying. It is preferable to ensure that all product trays have the same dwell time in the post-drying container and/or the cooling container. The loading of the post-drying container and/or the cooling container therefore takes place in the same sequence as the unloading of the post-drying container and/or the cooling container.

In a preferred embodiment of the device according to the invention, the control unit is configured for continuous operation in such a way that
c) the product trays can be continuously conveyed into the receiving compartments of a subsequent container, in particular a further post-drying container or the cooling container, or into the discharge airlock by the displacement unit arranged upstream of the subsequent container or the discharge airlock after reaching the respective target degree of treatment, in particular the target post-drying degree or the target cooling degree.

Essentially, any number of subsequent containers can be installed to achieve, for example, improved or intensified drying, or to be able to carry out drying more gently at lower temperatures, or to speed up the process as a whole. All in all, the device can be individually adapted to the product to be dried and the conditions on site.

The control unit for continuous operation can also be configured so that the product trays can be removed from the receiving compartments in the same order in which they are loaded. In this way, the maximum post-drying time of the first product tray is used in the best possible way to fill the receiving compartments. The number of storage compartments can be based on the total drying time of a product tray and the duration of the loading or unloading process.

It is preferable if the receiving compartments can be moved in a vertical direction by a lifting device. As the receiving compartments can be moved in a vertical direction, the displacement device can be vertically stationary. This significantly simplifies the design, especially as the sliding device can also be arranged outside the containers in this configuration. This makes it easier to maintain the sliding device.

The receiving compartments can preferably be individually tempered, in particular heated or cooled. In this way, very precise temperature control is possible. The proximity of the heat source to the product is particularly helpful in achieving uniform and easily controllable drying. Specifically, the receiving compartments can have heat exchanger plates that serve as a source of infrared radiation. Preferably, the heat exchanger plates form the support for the product trays so that the infrared heat radiation can be emitted directly to the product trays. The product trays themselves preferably comprise a thermally conductive material in order to be able to transfer the heat to the products to be dried.

The number of receiving compartments of the post-drying container preferably corresponds to at least the number of receiving compartments of the cooling container. This also ensures that continuous operation can take place, as the product trays can be transferred from one drying station to the next in the same cycle without having to accept extended dwell times in a drying station.

In a further preferred embodiment of the device according to the invention, the displacement unit comprises at least one swivel arm which, on the one hand, can be moved along the conveying path of the product tray and, on the other hand, can be removed from the conveying path of the product tray. As the swivel arm can be moved along the conveying path of the product tray, the swivel arm can be used to transfer the product tray from one container to the next, i.e. to move it along its conveying path. In this way, the product tray can be unloaded from a container, for example. However, to ensure that the conveying path of the following product tray is not obstructed when loading a container, the swivel arm can be removed from the conveying path of the product tray.

The displacement unit can also have at least one guide, in particular two guides, which extend along the conveying path and delimit it. The guides ensure a safe and precise conveying movement between the individual containers.

It may be provided that the guide, in particular one of the two guides, has a rolling surface, in particular a profiled rolling surface, on which the product tray rolls when moving along its conveying path. The rolling of the product tray on a guide has the advantage that the position of the product tray changes automatically when conveying from one container to another, i.e. the product tray rotates relative to the respective receiving compartment. The product tray is therefore rotated during the transition from a heat exchanger plate of one receiving compartment to another heat exchanger plate of the next receiving compartment in a subsequent container, ensuring that the heat input into the product tray is uniform.

A rotary movement of the product tray can be controlled particularly well if the rolling surface is profiled. For example, the rolling surface can be a toothed surface. It is also preferable if the product tray has a corresponding counter-toothing so that rotation through a predetermined angle is ensured.

In this respect, a preferred embodiment provides that the profiling and/or length of the rolling surface is dimensioned in such a way that the product tray describes a rolling angle of 90° to 270°, in particular of 150° to 210°, in particular 180°. Specifically, it is particularly preferable if the product tray rotates by 180° during the transition from one container to the next. This ensures that all products on the product tray are essentially uniformly exposed to the corresponding heat. This can improve the drying result.

In a further preferred embodiment, it is provided that the displacement unit has at least one measuring unit which is configured to detect at least one measured variable for determining process progress data during the transition of the product tray between the microwave treatment chamber, the post-drying container, the cooling container and/or the discharge airlock. The measured variable can be in particular a surface temperature of the product tray, a product moisture and/or a product mass. The detection of the product mass or its change can serve as an indicator for balancing the drying progress. It is also particularly preferable if the control unit is set up in such a way that the drying process is controlled using the measured variables recorded by the measuring unit. This allows the device to be individually adapted to the conditions of the particular product to be dried. If, for example, it is detected after the microwave treatment chamber that the preferred degree of drying has not been fully achieved, the drying time or drying temperature in the post-drying container can be adjusted accordingly. As a result, extremely uniformly dried products can be produced.

In a further embodiment of the invention, the microwave treatment chamber can also have a movable receiving device, in particular a turntable, for receiving the product tray, wherein a drive system of the receiving device has a measuring cell for determining a change in mass of the products during the microwave treatment. It has been shown that the integration of such a measuring cell into the drive system of the receiving device is particularly simple and can be used efficiently to record the drying progress in the microwave treatment chamber. The mass change developed by the measuring cell in the drive system of the receiving device can be used as an input data set for the control unit in order to adapt the subsequent process steps according to the degree of drying after the microwave treatment.

An alternative independent aspect of the invention relates to a method for drying and puffing organic, water-moist products, in particular fruits and/or vegetables, using a device described above. In the method according to the invention
a) the receiving compartments of the post-drying container are successively loaded with product trays from the microwave treatment chamber and
b) the product trays are continuously conveyed into the receiving compartments of a subsequent container, in particular a further post-drying container or the cooling container, by the displacement unit arranged upstream of the post-drying container after the respective target post-drying degree has been reached.

The advantages and preferred further developments mentioned in connection with the device described above also apply accordingly to the drying and puffing process according to the invention.

It is preferably provided in the method according to the invention that
c) the product trays are continuously conveyed into the receiving compartments of a subsequent container, in particular a further post-drying container or the cooling container, or into the discharge airlock by the displacement unit arranged upstream of the subsequent container or the discharge airlock after reaching the respective target degree of treatment, in particular the target post-drying degree or target cooling degree.

The device described herein and the associated method are preferably used for drying and puffing organic, water-moist products, in particular fruits and/or vegetables. However, the field of application of the device and method according to the invention goes further and covers all organic products that are moist with water. Mixtures of organic products with a water moisture content can also be treated. This applies in particular to mixtures of or with fruits and vegetables.

### DESCRIPTION OF DRAWINGS

The invention is explained in more detail below with reference to an exemplary embodiment shown in the attached schematic drawings, wherein:

FIG. 1 shows a schematic representation of a device according to the invention for drying and puffing organic, water-moist products;

FIG. 2 shows a top view of a sectional view of a device according to the invention as shown in FIG. 1, showing the sliding movement of a product tray;

FIG. 3 shows a cross-sectional view through a post-drying container of the device according to FIG. 1;

FIG. 4 shows a top view of a displacement unit of the device according to FIG. 1;

FIG. 5 shows a schematic representation of a heat exchanger plate, a receiving compartment, a product tray and a guide of the displacement unit to explain the usefulness of a rolling mechanism for the product tray; and

FIG. 6 shows a top view of a displacement unit with profiled guide for rolling a product tray.

### DESCRIPTION OF AN EMBODIMENT

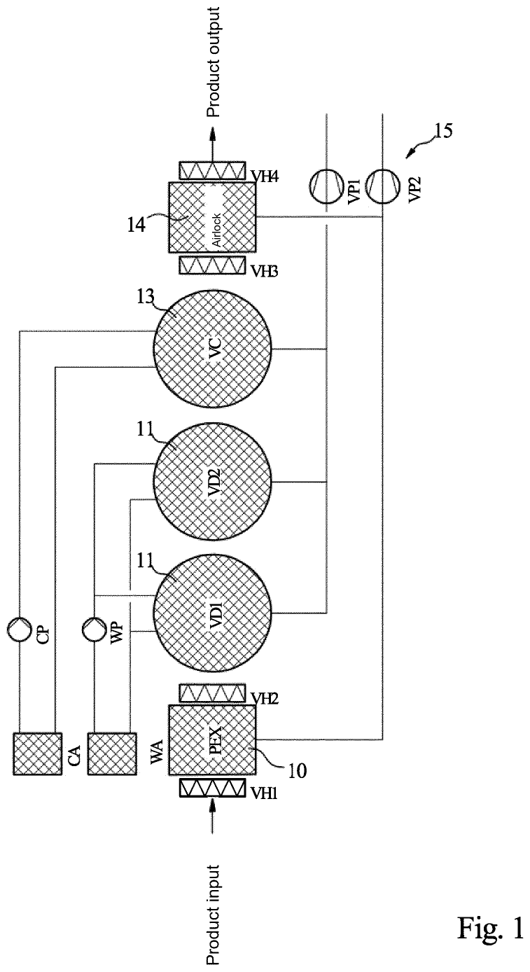

FIG. 1 shows a schematic overview of a device according to the invention for drying and puffing organic, water-moist products. The device comprises several chambers and containers, which are arranged one behind the other in the conveying direction of the product to be dried. In this way, various drying stages are implemented.

A first drying stage is formed by a microwave treatment chamber 10. The microwave treatment chamber 10 is connected to a vacuum unit 15. The vacuum unit 15 essentially forms a vacuum pump which generates a vacuum in the microwave treatment chamber 10. A vacuum seal VH1, VH2 is arranged in each case directly upstream and downstream of the microwave treatment chamber 10. A first post-drying container 11 is arranged downstream of the microwave treatment chamber 10 in the conveying direction of the products. The first post-drying container 11 is followed by a second post-drying container 11. In the exemplary embodiment shown, therefore, two essentially identically constructed post-drying containers 11 are provided. More than two post-drying containers 11 can be connected in series, especially if spatial conditions or customer-specific process sequences require it. However, it is also possible for the device to comprise only one post-drying container 11.

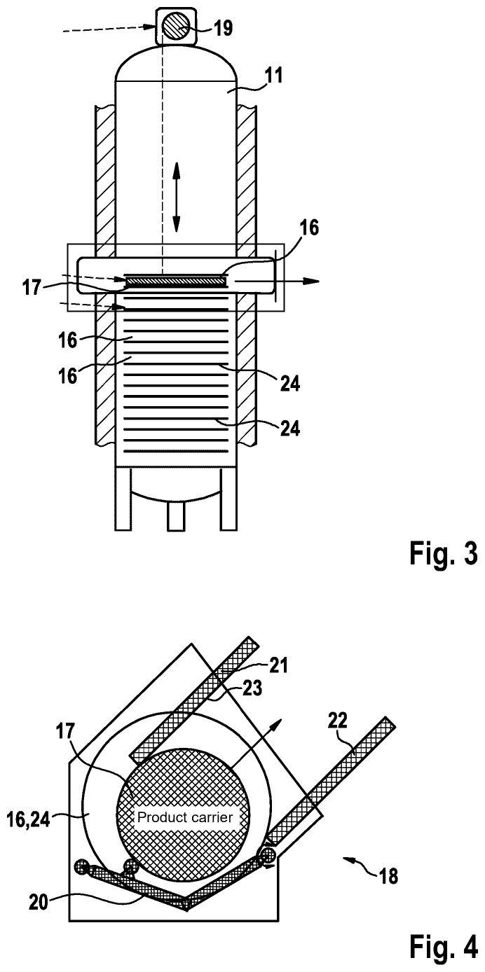

The post-drying container 11 is also connected to a vacuum unit 15 so that the pressure in the post-drying container 11 can be controlled. In addition, the post-drying container 11 has a connection to a heat source WA, which preferably comprises a liquid-filled heat circuit. The liquid-filled heat circuit is preferably controlled by a heat circuit pump WP. The heat circuit is connected to heat exchangers 24 or infrared radiation sources, which are arranged in the receiving compartments 16 for the product trays. The receiving compartments 16 are each located in the post-drying containers 11. The structure and arrangement of the receiving compartments 16 are explained in more detail later in connection with FIG. 3.

A cooling container 13 follows the post-drying container 11, in particular the second post-drying container 11, in the conveying direction of the products. The cooling container 13 has essentially the same structure as the post-drying container 11. The cooling container 13 is also connected to the vacuum unit 15.

The vacuum unit 15 can comprise one or more vacuum pumps VP1, VP2. An embodiment with only one vacuum pump VP1 is possible. In the exemplary embodiment shown here, however, two vacuum pumps VP1, VP2 are provided. A first vacuum pump VP1 is connected to the post-drying containers 11 and the cooling container 13, so that a uniform pressure can be set simultaneously in these containers. However, the pressures in the individual containers can also be set individually via valves. A second vacuum pump VP2 is coupled to the microwave treatment chamber 10 and a discharge airlock 14, so that the pressures in these containers or chambers can be set simultaneously and uniformly. Individual pressure settings can also be made here using valves. The two vacuum pumps VP1, VP2 of the vacuum pump unit 15 can preferably be controlled separately from each other. This means that different pressures can be set in the microwave treatment chamber 10 and the discharge airlock 14 than in the post-drying container 11 and the cooling container 13.

The cooling container 13 is also connected to a cooling source CA, which comprises a coolant circuit. The coolant circuit also has a coolant pump CP. The coolant circuit is also connected to heat exchangers arranged at the receiving compartments 16. The heat exchangers essentially form a second infrared radiation source, which operates at a lower temperature than the first infrared radiation source. In this way, the heat required for drying can be removed again from the dried products in the cooling container, so that the products are cooled to a predetermined temperature. Preferably, the products can be cooled to room temperature.

A discharge airlock 14 is located downstream of the cooling container 13 in the conveying direction of the products. A third vacuum seal VH3 is located between the cooling container 13 and the discharge airlock 14. A fourth vacuum seal VH4 is located downstream of the discharge airlock 14 in the conveying direction of the products. The product can leave the device via the fourth vacuum seal VH4.

Preferably, the post-drying containers 11 and the cooling container 13 are arranged in a uniform chamber, which is sealed off by the second vacuum seal VH2 and the third vacuum seal VH3. This allows the products to be transferred between the individual containers without pressure fluctuations.

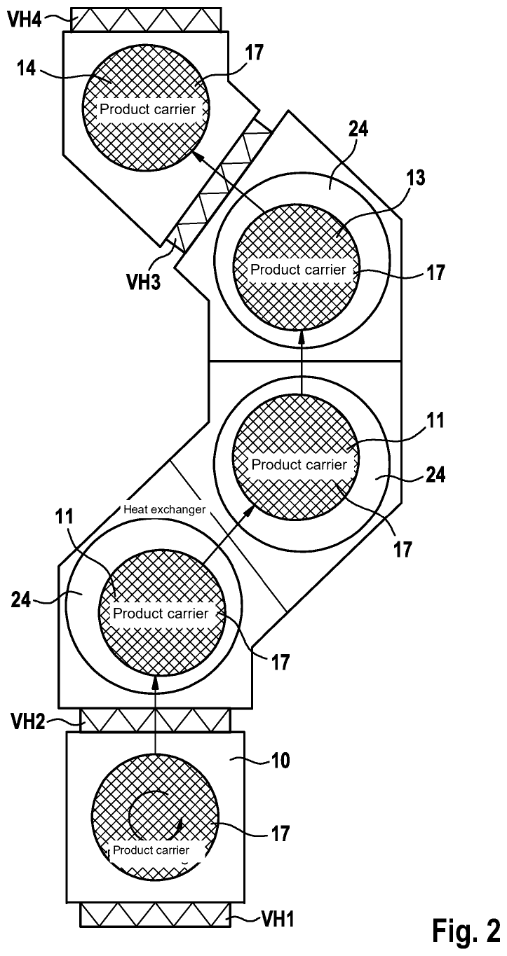

FIG. 2 shows a top view of a possible arrangement of the individual containers or chambers in relation to each other. In addition, FIG. 2 shows by means of arrows how a product tray 17 preferably passes through the device. The product tray 17 first enters the microwave treatment chamber 10 via the first vacuum seal VH1. There, the product tray 17 is positioned on a receiving device (e.g. a turntable), which moves, preferably rotates, the product tray 17 so that uniform microwave treatment is ensured. At the same time, the receiving device can be moved vertically in order to ensure uniform heating of the products by the microwave radiation.

The drive system of the receiving device preferably comprises a measuring cell for determining product data to evaluate the drying process during microwave treatment. Such a measuring cell can, for example, be formed by a load cell that monitors the mass of the products. A change in the mass of the products indicates the respective degree of drying, so that the microwave treatment process can be stopped as soon as a certain degree of drying or a certain product mass change has been achieved.

The product tray 17 is then transferred to the first post-drying container 11, wherein the product tray 17 is placed in a receiving compartment 16. The bottoms of the receiving compartments 16 each have heat exchangers 24, which are coupled to the heat circuit. The heat exchangers 24 can, for example, be plates through which liquid flows. These plates form a source of infrared radiation that transfers heat to the products. This heat ensures the post-drying process.

Preferably, the receiving compartments 16 are moved vertically during the drying process, so that the receiving compartments 16 can be successively or intermittently loaded with new product trays 17 from the microwave treatment chamber 10. The vertical movement of the receiving compartments 16 takes place in both directions, so that a receiving compartment 16 is first moved vertically in one direction and then back in the opposite direction after loading. This brings the receiving compartment 16 back to the height of a displacement unit 18, which can transfer the product tray 17 to the next post-drying container 11. The dwell time or travel time of the receiving carrier 16 corresponds to a predetermined period of time, which leads to the desired degree of drying of the respective product.

In the device according to FIG. 2, the product tray 17 then passes into a second post-drying container 11. The transfer between the microwave treatment chamber 10 and the post-drying containers 11 or between the post-drying containers 11 or between a post-drying container 11 and a cooling container 13 as well as between the cooling container 13 and the discharge airlock 14 takes place via displacement units 18, which are explained in more detail later in connection with FIG. 4.

In the device shown in FIG. 2, the product tray 17 is transferred from the second post-drying container 11 to the cooling container 13. There are also several receiving compartments 16 in the cooling container 13, which move vertically. Each receiving compartment 16 carries a heat exchanger 24, which is, however, connected to a coolant circuit. The heat exchanger 24 can therefore be formed by a plate through which liquid flows, wherein a liquid with a lower temperature flows through the plate than through the heat exchanger plates 24 in the post-drying containers 11. In this way, the temperature that was previously introduced into the products in the post-drying containers 11 is removed from the products in the cooling container 13. After the cooling process in the cooling container 13, the product tray 17 is transferred to the discharge airlock 14. The product tray 17 can then be removed from the discharge airlock 14 and leaves the device for drying and puffing organic, water-moist products.

FIG. 3 shows a schematic cross-sectional view of a post-drying container 11. A cooling container 13 can also have the same structure. Essentially, the post-drying container 11 is designed as a silo-like tank, which forms a conveyor track in a central area. A product tray 17 can enter the post-drying container 11 via the conveyor track and leave it again opposite. A number of receiving compartments 16 are arranged in the post-drying container 11, which are designed in a shelf-like manner. The shelf with receiving compartments 16 is vertically displaceable, wherein a lifting device in the form of a winch 19 is provided for this purpose, which pulls the receiving compartments 16 vertically upwards or lowers them vertically downwards. Each receiving compartment 16 carries a heat exchanger 24, which is connected to a heat source in the case of the post-drying containers 11. In the case of the cooling container 13, the heat exchanger 24 is coupled to a coolant circuit.

To post-dry the products, a product tray 17 is inserted into the post-drying container 11, wherein the product tray 17 is pushed into a receiving compartment 16. The receiving compartment 16 is then moved vertically upwards, while a negative pressure prevails in the post-drying container 11 and infrared radiation is simultaneously emitted onto the products via the heat exchangers. The heat exchangers therefore form the infrared radiation sources. As soon as the receiving compartment 16 reaches the top dead center of the lifting path, the direction of movement of the winch 19 is reversed and the receiving compartment 16 moves vertically downwards. As soon as the receiving compartment 16 reaches the conveying path again, the product tray 17 is ejected from the post-drying container 11 by the displacement unit 18 and transferred to another post-drying container 11 or the cooling container 13. The discharge therefore takes place during a pause in the downward movement of the shelf from receiving compartments 16.

Conversely, it is also possible that the lowest receiving compartment 16 is loaded first, then the shelf is lowered from receiving compartments 16 and raised again, so that the product trays 17 are ejected from receiving compartments 16 during a pause in the upward movement of the shelf.

The speed of the vertical movement of the receiving compartments 16 is preferably set to the dwell time of a product tray 17 so that the products arranged thereon leave the post-drying container 11 with a predetermined degree of drying. At the same time, the speed of the vertical movement of the receiving compartments 16 is set so that product trays 17 can be continuously fed out of the microwave treatment chamber 10. In this way, a clocked but continuous drying operation can be achieved, resulting in a high efficiency of the device.

FIG. 4 schematically shows a displacement unit 18, which is arranged between two containers. Preferably, a displacement unit 18 is arranged between the microwave treatment chamber 10 and the post-drying container 11, between the post-drying container and the cooling container 13 and between the cooling container 13 and the discharge airlock 14. The displacement unit 18 can also be provided upstream of the microwave treatment chamber 10, just as a further displacement unit 18 can be arranged downstream of the discharge airlock 14. If several post-drying containers 11 are provided, further displacement units 18 can be provided between each of these post-drying containers 11.

The displacement unit 18 comprises a swivel arm 20, which can be moved along the conveying path of the product tray 17. The swivel arm 20 can engage in a receiving compartment 16 in order to grip the product tray 17 and move it along the conveying path. In order to ensure a safe direction of movement for the product tray 17, two guides 21, 22 are preferably provided, which delimit the conveying path for the product tray 17. The swivel arm 20 can push the product tray 17 between the guides 21, 22 and move it within the guides 21, 22 to the next container. The swivel arm 20 can also be rotated so that it can be swiveled completely out of the conveying path of the product tray 17 so as not to block the conveying path.

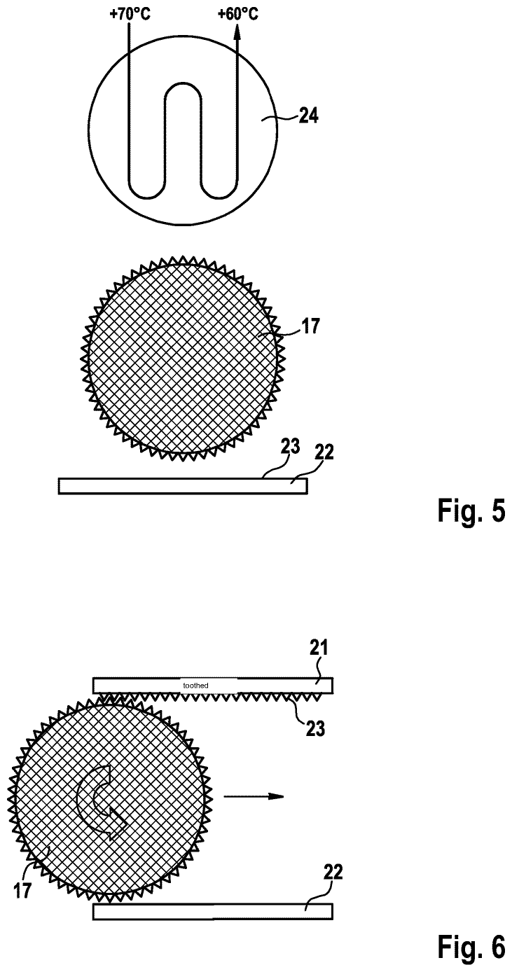

FIG. 5 schematically shows a heat exchanger 24, which is designed as a heat exchanger plate. Liquid ducts run through the heat exchanger plate so that a liquid heat transfer medium can flow through the heat exchanger plate. As the heat exchanger transfers its temperature to the product tray 17, different temperatures are set in the heat exchanger. FIG. 5 shows, for example, that the heat exchanger 24 has a temperature of around 70 °C in the area where the heat exchanger fluid enters, whereas the heat exchanger has a temperature of only 60 °C in the area where the heat exchanger fluid exits.

In order to nevertheless achieve uniform heating and drying of the products on the product tray 17, it is provided that at least one of the guides 21, 22 has a rolling surface 23 on which the product tray 17 rolls when moving along the conveyor track. The rolling surface 23 can be profiled, as shown as an example in FIG. 6. Two guides 21, 22 are shown, which delimit the conveying path for the product tray 17. A first guide 21 has a profiled rolling surface 23, which is designed in particular as toothing. The product tray 17 has a corresponding mating toothing, so that the product tray 17 rotates by a predetermined angle during conveying along the conveying path. This makes it possible for the product tray 17 to rotate by 180° between two containers. In particular, the product tray 17 can rotate through 180° between the first post-drying container 11 and the second post-drying container 11, so that the area of the product tray 17 that is previously arranged on the warmer side of the heat exchanger 24 is exposed to the colder side of the heat exchanger 24 in the second post-drying container 11. This ensures uniform heating of the products.

### LIST OF REFERENCE SIGNS

10 Microwave treatment chamber
11 Post-drying container
13 Cooling container
14 discharge airlock
15 Vacuum unit
16 Receiving compartment
17 product tray
18 Displacement unit
19 Lifting device, winch
20 Swivel arm
21 First guide
22 Second guide
23 Roll-off container
24 Heat exchanger
CA Cooling source
CP Coolant pump
VH1-VH4 Vacuum seal
VP1, VP2 Vacuum pump
WA Heat source
WP Heat circuit pump

1-15. (canceled)

16. A device for drying and puffing organic, water-moist products, in particular fruits and/or vegetables, having
a microwave treatment chamber;
at least one first vacuum-drying container having a first infrared radiation source;
at least one vacuum-cooling container having a second infrared radiation source; and
a discharge airlock, which are each connected to at least one vacuum unit respectively, wherein the first vacuum-drying container and the vacuum-cooling container each have a plurality of receiving compartments for product trays, which are arranged substantially vertically, wherein in each case a displacement unit is arranged upstream of the first vacuum-drying container and the vacuum-cooling container in the conveying direction of the product trays and a height position of the receiving compartments and the displacement unit can be changed relative to each other in order to load the receiving compartments individually with product trays for continuous operation and/or to unload them.

17. The device according to claim 16, wherein a control unit is connected at least to the microwave treatment chamber, the first vacuum-drying container, the vacuum-cooling container and the displacement unit, wherein the control unit is configured for continuous operation in such a way that:
a) the receiving compartments of the first vacuum-drying container can be successively loaded with the product trays from the microwave treatment chamber, and
b) the product trays can be continuously conveyed into the receiving compartments of a second vacuum-drying container or the vacuum-cooling container, by the displacement unit arranged upstream of the first vacuum-drying container once a respective target moisture content has been reached.

18. The device according to claim 17, wherein the control unit is configured for continuous operation in such a way that:
c) the product trays can be continuously conveyed into the receiving compartments of a second vacuum-drying container or the vacuum-cooling container, or into the discharge airlock by the displacement unit arranged upstream of a second vacuum-drying container or the discharge airlock after reaching the respective target degree of treatment.

19. The device according to claim 17, wherein the control unit is configured for continuous operation in such a way that the product trays can be removed from the receiving compartments in a same order in which they are loaded.

20. The device according to one of claims 16, wherein the receiving compartments can be moved in a vertical direction by a lifting device.

21. The device according to one of claims 16, wherein the receiving compartments can be individually tempered.

22. The device according to one of claims 16, wherein a number of receiving compartments of the first vacuum-drying container corresponds to at least a number of receiving compartments of the vacuum-cooling container.

23. The device according to one of claims 16, wherein the displacement unit further comprises at least one swivel arm which can be moved along a conveying path of the product tray and can be removed from the conveying path of the product tray.

24. The device according to one of claims 16, wherein the displacement unit has at least one guide which extends along a conveying path and delimit it.

25. The device according to claim 24, wherein the guide has a rolling surface on which the product tray rolls during movement on a conveyor track.

26. The device according to claim 25, wherein a profiling and/or a length of the rolling surface is dimensioned in such a way that the product tray describes a rolling angle of 90° to 270°.

27. The device according to claim 16, wherein the displacement unit has at least one measuring unit which is configured to detect at least one measured variable for determining process progress data during a transition of the product tray between the microwave treatment chamber, the first vacuum-drying container, the vacuum-cooling container and/or the discharge airlock, wherein the at least one measured variable is a surface temperature of the product tray, a product moisture content and/or a product mass.

28. The device according to claim 16, wherein the microwave treatment chamber has a movable receiving device for receiving the product tray, and wherein a drive system of the receiving device has a measuring cell for determining a change in mass of the products during microwave treatment.

29. A method for drying and puffing organic, water-moist products having the device according to claim 16, in which:
a) the receiving compartments of the first vacuum-drying container are successively loaded with the product trays from the microwave treatment chamber; and
b) the product trays are continuously conveyed into the receiving compartments of a second vacuum-drying container or of the vacuum-cooling container, by the displacement unit arranged upstream of the first vacuum-drying container after the respective target moisture content has been reached.

30. The method according to claim 29, wherein:
c) the product trays are continuously conveyed into the receiving compartments of a second vacuum-drying container or the vacuum-cooling container, or into the discharge airlock by the displacement unit arranged upstream of the second vacuum-drying container or the discharge airlock after reaching a respective target degree of treatment.
